(19) United States
(12) Patent Application Publication
(10) Pub. No.: US 2025/0371532 A1
(43) Pub. Date: Dec. 4, 2025

(54) SMART MOBILE WALLET TRACKER FOR MONITORING AND COMPLIANCE

(71) Applicant: Wells Fargo Bank, N.A., San Francisco, CA (US)

(72) Inventors: Caroline A. Machado, Mountain View, CA (US); Tiffany N. Twilley, Tiburon, CA (US); Young M. Yang, San Francisco, CA (US)

(21) Appl. No.: 18/679,887

(22) Filed: May 31, 2024

(51) Int. Cl. G06Q 20/38; G06Q 20/20; G06Q 20/36

(52) U.S. Cl. CPC G06Q 20/389; G06Q 20/20; G06Q 20/36

(57) ABSTRACT

Systems and methods are directed to automatic tracking and categorization of transactions in real-time for transaction record regeneration. A smart wallet system receives, via a smart wallet mobile system activated on a mobile device, transaction data for a transaction. Responsive to receiving the transaction data, a tracker component performs, in real-time as the transaction is completed, operations comprising determining whether an item of the transaction is to be categorized into a tracker category and categorizing the item of the transaction into the tracker category in response to determining that the item of the transaction is to be categorized into the tracker category. Responsive to a record trigger event, a record component of the smart wallet system generates or updates a transaction record for the tracker category. A submission component submits the transaction record to a third-party system, which triggers the third-party system to process the transaction record.

### TECHNICAL FIELD

The subject matter disclosed herein generally relates to mobile wallets. Specifically, the present disclosure addresses systems and methods for automated transaction tracking, categorization, and record generation and submission for transactions performed using a mobile wallet.

### BACKGROUND

Typically, users need to track various transactions for a variety of reasons. For example, transactions can include medical expenses, business-related expenses, charitable contributions, educational expenses, childcare expenses, purchases that include value-added tax (VAT), and the like. These users may be eligible for reimbursement of at least a portion of these transactions, such as from a health savings account (HSA) or flexible spending account (FSA), from an associated business, as a tax deduction, or as a VAT refund. Thus, users need to keep track of receipts of these eligible expenditures to submit for these reimbursements. Oftentimes, however, this requires tracking and keeping of physical copies of transaction receipts and submission of these receipts in an accepted format to a proper third-party or authority.

### BRIEF DESCRIPTION OF THE DRAWINGS

FIG. 1 is a diagram illustrating an example network environment suitable for providing a mobile wallet having smart wallet tracker functionalities, according to example implementations.

FIG. 2 is a diagram illustrating components of a smart wallet system, according to example implementations.

FIG. 3 is a flowchart illustrating operations of a method for automatically categorizing transactions conducted using a smart wallet, according to example implementations.

FIG. 4 is a flowchart illustrating operations of a method for generating and submitting a transaction record, according to example implementations.

FIG. 5 is a flowchart illustrating operations of a method for managing rules including machine learning updates to the rules, according to example implementations.

FIG. 6 is a block diagram illustrating components of a machine, according to some examples, able to read instructions from a machine-storage medium and perform any one or more of the methodologies discussed herein.

### DETAILED DESCRIPTION

The description that follows describes systems, methods, techniques, instruction sequences, and computing machine program products that illustrate examples of the present subject matter. In the following description, for purposes of explanation, numerous specific details are set forth in order to provide an understanding of various examples of the present subject matter. It will be evident, however, to those skilled in the art, that examples of the present subject matter can be practiced without some or other of these specific details. Examples merely typify possible variations. Unless explicitly stated otherwise, structures (e.g., structural components) are optional and can be combined or subdivided, and operations (e.g., in a procedure, algorithm, or other function) can vary in sequence or be combined or subdivided.

Systems and methods that provide a smart mobile wallet system or platform are discussed herein. The smart mobile wallet system can link multiple user accounts and financial instruments (e.g., bank accounts, credit card accounts) and mobile identifiers (e.g., mobile driver license, passport, visa) and track transactions using these user accounts along with cash or gift card transactions. Specifically, a smart mobile wallet system is configured to be a central management system having smart tracker features that automatically identify categorically eligible transactions, and specifically, eligible items in these transactions, regardless of the financial instrument used to conduct the transaction (e.g., cash, different credit/debit cards, gift cards) and generate a transaction record for particular tracker categories. The transaction record can be accessed or provided to the user for review and editing. Furthermore, the transaction records can be submitted to a third-party, for example, to seek reimbursement. In some cases, the transaction records are automatically generated and/or submitted without any user intervention or input.

Thus, example implementations configure a smart mobile wallet (and/or a smart wallet system) to keep a record of and categorize transactions made using the smart mobile wallet that satisfy particular criteria. In particular, the smart wallet system creates tracker categories and configures one or more rules that are indicative of what items and/or transactions to track and circumstances under which to track the items/transactions for each tracker category. For example, a VAT tracker category can be established with rules to record transactions made in certain geographic areas. As another example, a medical tracker category can be established with rules to record medical-related transactions made from certain merchants and/or with items having particular identification codes (e.g., merchant category code (MCC), stock keeping unit (SKU) number).

These tracker categories and rules can be established by a user or determined automatically by the system, such as via machine learning. Once established, the tracker categories and rules can be refined with machine learning. For instance, machine learning can be used to identify/refine the categorically eligible transactions, categorically eligible items, and/or user preferences. The user preferences can include, for instance, use of particular accounts for certain transactions or transaction types, how and when transaction records are generated, and whether certain transaction records are submitted automatically without user intervention or input.

Once the smart mobile wallet is activated, the user can make purchases as they would normally using their smart mobile wallet. The smart mobile wallet (or a backend server of the smart wallet system) is configured to determine whether each transaction corresponds to rules defined for a tracker category. If so, a component of the smart mobile wallet automatically includes the transaction (or eligible item) in a transaction record. Each transaction in the transaction record can include transaction details or data (e.g., date, transaction amount, merchant identifier, payment instrument used), and can also include indicia of a mobile identifiers (e.g., mobile driver's license or passport) associated with the smart mobile wallet used to complete the transaction.

In some situations, a user can provide an indication, via a user interface, to the smart mobile wallet that a particular transaction should be (or should not be) recorded to a particular tracker category. This indication or feedback can trigger the smart mobile wallet to update the rules for the tracker category. Alternatively or additionally, the feedback can be used by a machine learning component to identify/refine the categorically eligible transactions, eligible items, and/or user preferences.

In some cases, the smart mobile wallet can be used to track transactions completed outside of the smart mobile wallet. For instance, the user can pay cash at a point-of-sale terminal and tap their smart mobile wallet against the point-of-sale terminal to retrieve transaction data. The smart mobile wallet can then append the mobile identifier to the transaction data. In doing so, the smart mobile wallet tracks transactions completed using legacy modes of payment.

Furthermore, by linking the mobile identifier to each transaction via the smart mobile wallet, additional verification that it was the user that completed the transaction is provided even when the transaction was completed using payment methods (e.g., cash) that are not inherently traceable. In this way, the smart tracker provides an identification audit trail in connection with transactions that can be relied-upon, for example, for tax or other benefits/reimbursement.

The user can request a transaction record for a purchase tracker category from the smart mobile wallet and/or the smart mobile wallet can automatically provide the transaction record, such as in response to particular rules or trigger events (e.g., monthly, a beginning of tax season, at an airport). The transaction record can be generated based on user output preference or requirements of a third-party system such that it can be directly submitted to the third-party system (e.g., tax refund agency, insurance company).

As a result, example implementations provide a technical solution to the technical problem of automated tracking and categorization of transactions using a smart mobile wallet. In particular, the technical solution is embodied within a smart wallet system operating on one or more servers. The smart wallet system receives, via a smart wallet mobile system activated on a mobile device of a user, transaction data for a transaction completed by the user (e.g., online or at a physical location such as a point-of-sale terminal). Responsive to receiving the transaction data, a tracker component of the smart wallet system is triggered to perform, in real-time as the transaction is completed, operations including determining whether an item of the transaction is to be categorized into a tracker category and categorizing the item of the transaction into the tracker category in response to determining that the item of the transaction is to be categorized into the tracker category. Responsive to a record trigger event, a record component of the smart wallet system is triggered to generate or update a transaction record for the tracker category. In response to a submission trigger event, a submission component of the smart wallet system is triggered to submit the transaction record to a third-party system, whereby submission of the transaction record triggers the third-party system to process the transaction record

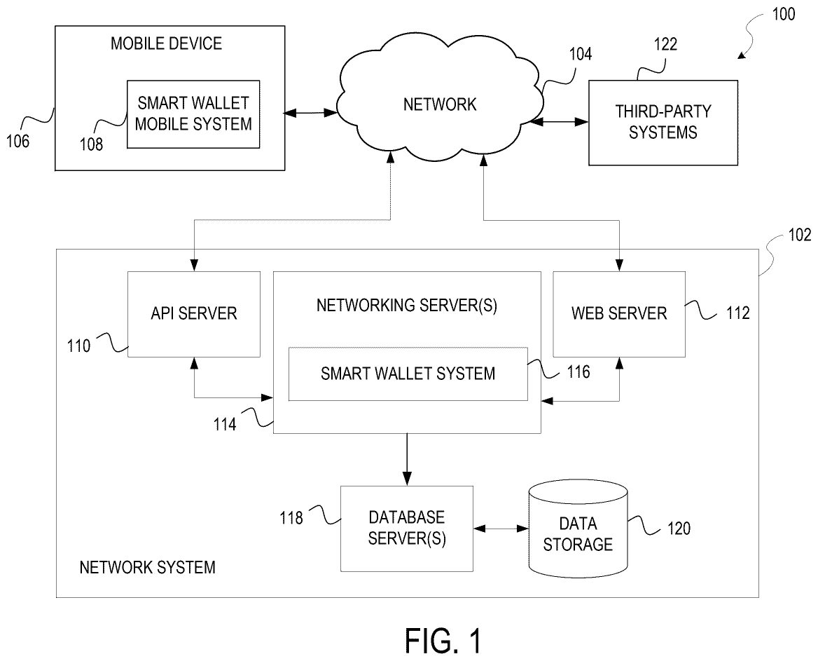

FIG. 1 is a diagram illustrating an example network environment 100 suitable for providing a mobile wallet having smart wallet tracker functionalities, according to example implementations. A network system 102 provides server-side functionality via a communication network 104 (e.g., the Internet, wireless network, cellular network, or a Wide Area Network (WAN)) to a mobile device 106. The network system 102 is configured to provide tracking, categorization, record generation and submission, and machine learning operations, as will be discussed in more detail below.

In various cases, the mobile device 106 is a device associated with a user of the network system 102 that wants to use their mobile device 106 to conduct mobile wallet transactions and/or automatically track transactions using functionalities of the network system 102 and/or a smart wallet mobile system 108. The mobile device 106 can comprise, but is not limited to, a smartphone, a tablet, a laptop, multi-processor systems, microprocessor-based or programmable consumer electronics, or any other portable communication device that can access the network system 102. The mobile device 106 can include the smart wallet mobile system 108 that exchanges data, via the network 104, with the network system 102. For example, the smart wallet mobile system 108 can be a local version of an application or component of the network system 102 that provides data to and accesses data from one or more components at the network system 102. In some implementations, the smart wallet mobile system 108 is downloaded from the network system 102.

In example implementations, the mobile device 106 interfaces with the network system 102 via a connection with the network 104. Depending on the form of the mobile device 106, any of a variety of types of connections and networks 104 can be used. For example, the connection can be Code Division Multiple Access (CDMA) connection, a Global System for Mobile communications (GSM) connection, or another type of cellular connection. Such a connection can implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, or other data transfer technology (e.g., fourth generation wireless, 4G networks, 5G networks). When such technology is employed, the network 104 includes a cellular network that has a plurality of cell sites of overlapping geographic coverage, interconnected by cellular telephone exchanges. These cellular telephone exchanges are coupled to a network backbone (e.g., the public switched telephone network (PSTN), a packet-switched data network, or other types of networks.

In another example, the connection to the network 104 is a Wireless Fidelity (e.g., Wi-Fi, IEEE 802.11x type) connection, a Worldwide Interoperability for Microwave Access (WiMAX) connection, or another type of wireless data connection. In such an example, the network 104 includes one or more wireless access points coupled to a local area network (LAN), a wide area network (WAN), the Internet, or another packet-switched data network. In yet another example, the connection to the network 104 is a wired connection (e.g., an Ethernet link) and the network 104 is a LAN, a WAN, the Internet, or another packet-switched data network. Accordingly, a variety of different configurations are expressly contemplated.

Additionally, the mobile device 106 can comprise a display component (not shown) to display information (e.g., in the form of user interfaces) including requests for confirmation on transactions, generated transaction records, rule options, and/or submission options, as will be discussed in more detail below.

Turning specifically to the network system 102, an application programing interface (API) server 110 and a web server 112 are coupled to and provide programmatic and web interfaces respectively to one or more networking servers 114. The networking servers 114 host various systems including a smart wallet system 116, which comprises a plurality of components and can be embodied as a combination of hardware, software, and/or firmware.

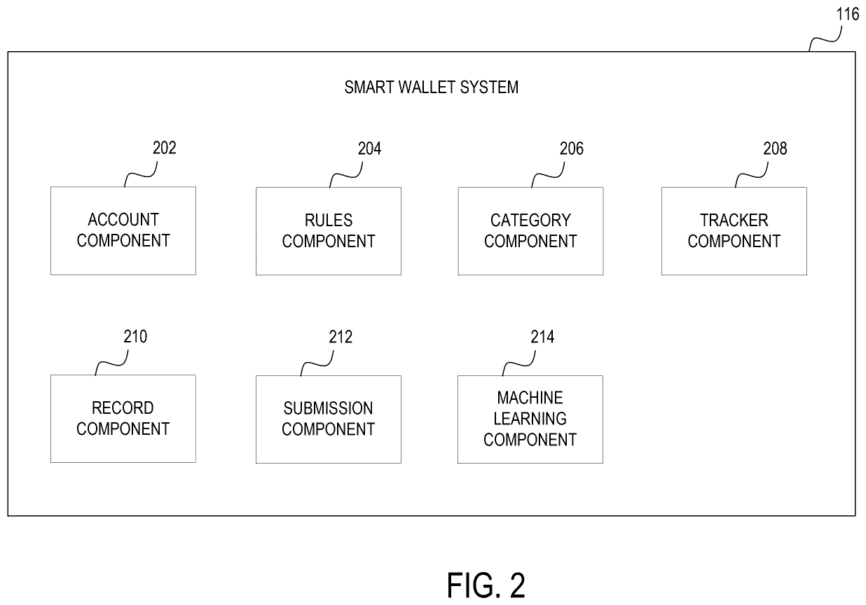

The smart wallet system 116 comprises components that manage automatic tracking and categorization of transactions in real-time as each transaction is completed for a plurality of mobile devices 106 and users. Subsequently, the smart wallet system 116 generates transaction records for compliance, monitoring (e.g., insurance deductibles), and/or submission (e.g., for reimbursement). In various embodiments, the smart wallet system 116 uses machine learning to refine categorization operations and user preferences. The smart wallet system 116 will be discussed in more detail in connection with FIG. 2 below.

The networking servers 114 can, in turn, be coupled to one or more database servers 118 that facilitate access to one or more storage repositories or data storage 120. The data storage 120 is a storage device storing, for example, user accounts including user profiles of users of the network system 102 and indications of corresponding rules/preferences, corresponding transactions with categorization, and transaction records that are generated and/or submitted for each user.

One or more third-party systems 122 are also networked to the network system 102. On the transaction side, the third-party systems 122 can comprise, for example, credit card company systems, bank systems (e.g., for debit card transactions), and payment service systems (e.g., PayPal, Apple Pay, Google Pay). On the record submission side (e.g., for reimbursement), the third-party systems 122 can comprise, for example, an HSA or FSA custodian system (e.g., bank, insurance company, brokerage that administers the HSA or FSA), a refund service system (e.g., VAT refund service), or a company's server (e.g., for reimbursement for a business trip). Submission of a transaction record by the smart wallet system 116 to the third-party system 122 triggers a component of the third-party system 122 to process the transaction record (e.g., for reimbursement).

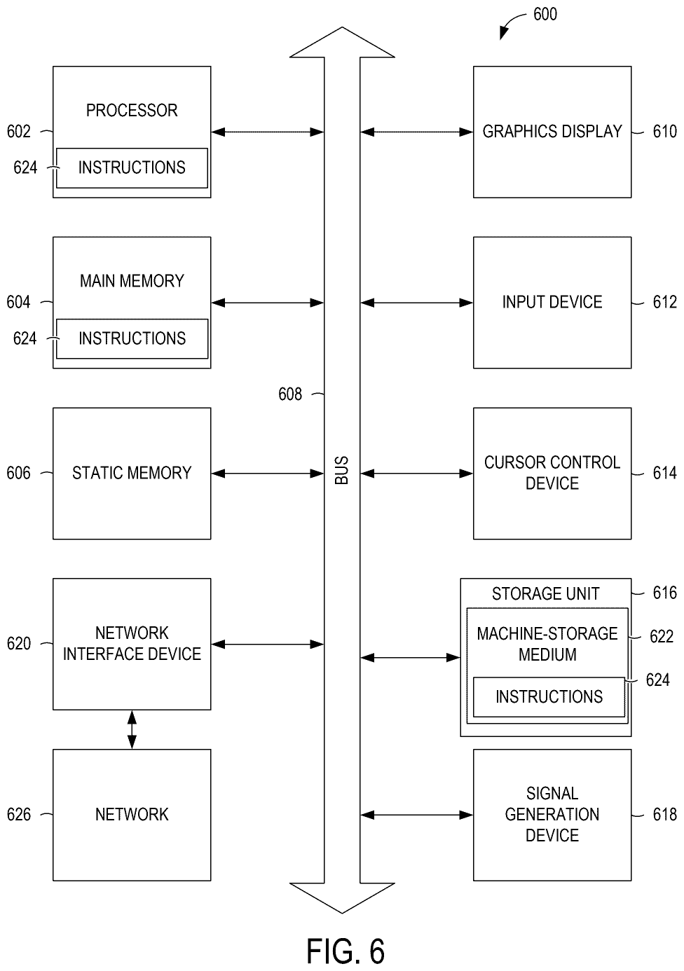

Any of the systems, data storage, or devices (collectively referred to as “components”) shown in, or associated with, FIG. 1 can be, include, or otherwise be implemented in a special-purpose (e.g., specialized or otherwise non-generic) computer that can be modified (e.g., configured or programmed by software, such as one or more software components of an application, operating system, firmware, middleware, or other program) to perform one or more of the functions described herein for that system or machine. For example, a special-purpose computer system able to implement any one or more of the methodologies described herein is discussed below with respect to FIG. 6, and such a special-purpose computer is a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

Moreover, any two or more of the components illustrated in FIG. 1 can be combined, and the functions described herein for any single component can be subdivided among multiple components. Functionalities of one component can, in alternative examples, be embodied in a different component. For example, some of the operations and components of the smart wallet system 116 can be embodied within the mobile device 106 (e.g., as part of the smart wallet mobile system 108). Additionally, any number of mobile devices 106 and data storage 120 can be embodied within the network environment 100. While only a single network system 102 is shown, alternatively, more than one network system 102 can be included (e.g., localized to a particular region).

FIG. 2 is a diagram illustrating components of the smart wallet system 116, according to example implementations. In example implementations, the smart wallet system 116 comprises one or more servers that manages automatic tracking and categorization of transactions in real-time and generation of transaction records for monitoring, compliance, and/or submission. To enable these operations, the smart wallet system 116 comprises an account component 202, a rules component 204, a category component 206, a tracker component 208, a record component 210, a submission component 212, and a machine learning component 214 all configured in communication with one another (e.g., via a bus, shared memory, or a switch). The smart wallet system 116 can comprise other components (not shown) that are not germane to example implementations. It is noted that some of the components of the smart wallet system 116 can additionally or alternatively be embodied at the mobile device 106. For example, the smart wallet mobile system 108 can include a mobile version of one or more of the components of the smart wallet system 116 that are discussed below.

The account component 202 is configured to manage accounts of users of the network system 102. Each account is linked to a user and can comprise information regarding one or more credit cards, debit cards, membership cards, and/or identity cards (mobile identifiers) or documents that can be accessed and used by the smart mobile wallet during a transaction. In some cases, the debit cards are linked to a health savings account (HSA) or a flexible spending account (FSA). The identity cards can include a driver license (e.g., mobile driver license), a passport (e.g., mobile passport), or any other form of government issued identity document. Thus, when a user uses their smart mobile wallet, the smart wallet mobile system 108 and/or the smart wallet system 116 accesses and uses information associated with one of the credit or debit cards and, in some cases, an identity card to complete a transaction.

The rules component 204 is configured to manage user settings including user preferences. In some cases, the user settings include one or more rules that indicate which card should be used for specific types of transactions. For example, the user can establish a rule that a HSA or FSA debit card is used at certain locations (e.g., doctor's office, pharmacy) or for certain categories of goods/services (e.g., medication, over-the-counter drugs).

In some case, a rule that a particular credit card be used for transactions in certain categories or locations based on benefits can be established. For example, a rule can indicate that an airline or travel benefit credit card be used for any airline transactions, while a hotel credit card or the travel benefit credit card be used for hotel transactions. In some cases, the rules can indicate to use a highest benefit card for a transaction. For instance, if a credit card has bonus benefits for certain categories of goods for a particular time period (e.g., 5% cash back for groceries this month), the rules component 204 can trigger the use of that credit card for those categories of goods or types of location (e.g., the grocery store). In example implementations, the benefit information can be accessed from the third-party system 122 (e.g., credit card company server) by the rules component 204. In some implementations, the rules include default rules which the user can change via the rule component 204 or by the machine learning component 214.

During a transaction, the user can present the mobile device 106 at a point-of-sale terminal to complete the transaction. The rules component 204 can read a merchant category code (MCC) or detect a stock keeping unit (SKU) of one or more items in the transaction. The rules component 204 then accesses the rules to determine which card to use. In some cases, the appropriate payment instrument is used automatically. In other cases, a notification (e.g., popup) is caused to be displayed on the mobile device 106 requesting confirmation from the user to use the card (e.g., if it is a card that is different than the card normally used for such a transaction).

The category component 206 is configured to manage tracker categories and category rules that indicate what transactions to track and/or circumstances under which to track the transactions for each tracker category. For example, a user can create a VAT tracker category via the category component 206 and define rules to record certain types of transactions made in certain geographic areas. As another example, a user can create a medical tracker category via the category component 206 with rules to record transactions made at certain physical locations (e.g., doctor's office) and/or with items having particular identification codes (e.g., merchant category code (MCC), stock keeping unit (SKU) number). In some cases, the tracker categories and category rules are established (e.g., selected from a drop-down menu or entered in a field) by a user. In other cases, a tracker category or corresponding category rules are default or set by the smart wallet system 118 and the user can adjust the default rules or provide additional rules via the category component 206 to customize the tracker category. As such, the tracker categories can be user-specific and allow for transactions that lack more defined rules (e.g., business-related expenses, charitable contributions, educational expenses, childcare expenses, energy credit related expenses, construction expenses) to still be categorized and tracked.

The category rules can indicate whether or which transactions should be automatically categorized without confirmation by the user and whether or which transactions require user confirmation for categorization. Similarly, the category rules can indicate whether and which tracker categories can have transaction records automatically generated and/or submitted without user intervention and whether and which tracker categories require some sort of user input for transaction record generation and submission. In some implementations, the category rules include default rules which the user can change via the category component 206 or by the machine learning component 214.

Machine learning can be used to determine and/or refine category rules for the tracker categories or categorically eligible transactions (e.g., types of items that are eligible). For example, if a user purchases crackers at Walgreens, which is a FSA category location, and indicates that this item is not a FSA eligible item or transaction, the machine learning component 214 takes this feedback and learns that similar items (e.g., according to MCC or SKU), such as cereal or cookies, are also not FSA eligible items. As such, future purchases of these similar items at an FSA category location will automatically not be categorized into the FSA category. The reverse is also true. Thus, if the user provides feedback that a particular item or transaction is categorically eligible, then the machine learning component 214 takes that feedback and learns that similar items and transaction are categorically eligible. In both examples, the machine learning component 214 triggers the category component 206 to update the category rules for the corresponding tracker category.

The tracker component 208 is configured to manage the categorization of transactions. In example implementations, the categorization occurs in real time as the transaction is completed. When the mobile device 106 is positioned near a point-of-sale terminal, for example, the smart wallet mobile system 108 receives, via wireless communication, transaction details including date, transaction amount, merchant identifier, and/or MCC or SKU associated with each item/service of the transaction. The transaction details are instantaneously transmitted to the tracker component 208 for categorization.

In some cases, a mobile identifier (e.g., mobile driver license or passport) is associated with the transaction by the smart wallet mobile system 108 and transmitted as part of the transaction details. By associating the mobile identifier to the transaction, the user can provide additional verification that it was the user that completed the transaction, even when the transaction was completed using payment methods (e.g., cash, gift card) that are not inherently traceable. For instance, for a cash payment at a point-of-sale terminal, the user can tap the mobile device 106 and the smart wallet mobile system 108 retrieves the transaction details and links the mobile identifier to the transaction as verification that the user made the purchase. This provides an identification audit trail in connection with transactions that can be relied on for tax or other benefits, for example. Additionally, if the user needs to present identification at the point-of-sale, the mobile identifier can be presented by the smart wallet mobile system 108 and the tracker component 208 can record that the transactions was verified using the mobile identifier.

Further still, the mobile identifier can be linked to the transaction for transactions that are user specific. For example, if the transaction involves an assigned ticket, the mobile identifier can be associated with the transaction and thus the ticket. Should the ticket later get transferred, the use of the mobile identifier makes the transfer more valid and/or less suspect.

Receipt of the transaction details by the smart wallet system 116 immediately triggers, the tracker component 208 to attempt to categorize the transaction. The tracker component 208 accesses tracker categories and corresponding rules established by the category component 206. Using the MCC and/or the SKU(s), the tracker component 208 identifies the merchant and/or the specific item(s) of the transaction. If the merchant and/or the specific item(s) satisfy a category rule of a tracker category, then the transaction is categorized in that tracker category. For example, if the MCC indicates that the merchant is a doctor's office, then the tracker component 208 can categorize the transaction in a HSA or FSA category and/or insurance deductible category. In some cases, the SKU can help differentiate between a category eligible item and a non-eligible item. For example, the MCC can indicate a drug store (e.g., CVS, Walgreens). However, drug stores typically sell items other than prescription and over-the-counter medications. In these cases, the system can obtain a SKU and based on the SKU, identify the type of item involved in a transaction (e.g., snack food versus a prescription) and the category rules can indicate what types of items (e.g., prescription and over-the-counter medications) should be categorized (e.g., are eligible) by the tracker component 208.

In another example, the category rules are associated with location(s) for a tracker category. For example, for a VAT refund category or business trip category, if the tracker component 208 detects that the transaction occurred in Europe (for the VAT refund category) or is a threshold distance from their home (for the business trip category), the tracker component 208 access category rules for these tracker categories and determines if transactions should be categorized into one of these tracker categories. The category rules can indicate, for example, that only physical good purchased in Europe should be categorized in the VAT refund category. In contrast, the category rules for the business trip category can indicate that transportation, hotel, and restaurant transactions should be categorized.

It is noted that a transaction can be included in more than one tracker category. For example, if a user is purchasing a prescription, the transaction can be categorized in a FSA category as well as an insurance deductible category.

In some implementations, the tracker component 208 provides a notice to the user on their mobile device 106 indicating whether the transaction has been categorized and/or the tracker category that the transaction was categorized into. The user can confirm (or do nothing) if the categorization is correct or provide an indication to change the categorization.

In some cases, the categorization is automatic unless the tracker component 208 is unable to automatically categorize the transaction. In these situations, the tracker component 208 can prompt the user (e.g., at time of purchase or shortly afterwards) to confirm whether and/or in which category the transaction (or items of the transaction) should be categorized. After an initial confirmation, the tracker component 208 can, in some implementations, automatically categorize a same or similar transaction without further user input or confirmation.

In example implementations, each tracker category can include transactions that took place using different financial or payment instruments. For instance, a business trip category can have a hotel transaction using a hotel branded credit card, an airfare transaction using an airline branded credit card, and one or more cash transactions for snacks or food items. Thus, the smart wallet system 116 provides a central management system capable of tracking transactions across multiple financial instruments in a plurality of different tracker categories at the same time for a plurality of different users.

Any indication that confirms a categorization or changes the categorization can be provided to the machine learning component 214, which learns revisions to rules and categorizations. In some cases, if a MCC does not trigger the categorization into a proper tracker category, the user can also set a rule, via the rules component 204, that every time a transaction at a merchant associated with a particular MCC occurs, it should be categorized into a particular tracker category. Similar rules can be established for types of items/services.

The record component 210 manages the generation and presentation of transaction records. Depending on the tracker category, the transaction record can be submitted for a reimbursement (e.g., business trip category, FSA or HSA category where a FSA or HSA card was not used), for a refund (e.g., VAT refund), or for record keeping (e.g., tax deductions, FSA or HSA category where a FSA or HSA card was used to pay for the transaction, insurance deductible, home construction expenditures).

The record component 210 is triggered to generate the transaction record based on triggering events. For instance, when a transaction is categorized into a tracker category, a transaction record can automatically be generated or updated (if one is already existing) to include a new transaction. In this implementation, a “running” transaction record can be maintained for the tracker category (e.g., for a particular time period or until submitted). In another example, the user can explicitly trigger a request for the transaction record (e.g., via an option presented by the smart wallet mobile system 108), which triggers the generation of the transaction record. In other cases, the record component 210 is triggered to automatically generate and provide the transaction record at particular time (e.g., monthly, beginning of tax season, on a specific date, as soon as the transaction is categorized). Further still, the record component 210 can automatically generate and present the transaction record based on location. For example, if the mobile device 106 is detected to be at an airport, the record component 210 can be triggered to generate a VAT refund transaction record. In some cases, when a record is generated or presented by the record component 210 is determined by one or more user settings established by default, the rules component 204, or the machine learning component 214.

The submission component 212 is configured to submit the transaction record generated by the record component 210. In some implementations, the generation of the transaction record by the record component 210 automatically triggers the submission component 212 to submit the transaction record to a corresponding third-party. For example, if the transaction involves an FSA transaction, the record component 210 can automatically generate the FSA transaction record after the transaction is completed, which triggers the submission component to automatically submit the FSA transaction record without user intervention or confirmation. In other cases, the user can establish a rule that requires user review and confirmation before submission. Further still, a user setting/rule can indicate that submissions occur at a predetermine time or when triggered by an event. For example, the submission component 212 can submit once a month, when the smart wallet system 118 detects the user is at a certain location (e.g., the airport), or when a particular reimbursement amount is reached. Additionally, the user can manually trigger submission. For instance, the user can select an option presented by the smart wallet mobile system 108 and the transaction record is presented to the user for review and submission.

In implementations in which the transaction record is not automatically generated and submitted immediate upon completion of the transaction, the transaction record can include a plurality of transactions that occur over time and potentially with different financial instruments. Thus, the record component 210 can consolidate transactions that occurred across different financial instructions, over a period of time, and at different physical locations into a single transaction record that can be submitted, by the submission component 212.

The machine learning component 214 is configured to learn various settings/rules and what transactions should be tracked by the tracker component 208 (e.g., exceptions to rules/settings). For example, if a user purchases crackers at a drug store and indicates to the smart wallet system 118 that this is not an FSA eligible item, the machine learning component 214 learns that this category of goods (e.g., based on MCC or SKU) should not be categorized by the tracker component 208. The machine learning component can further learn what related categories of goods (e.g., cookies, bread, cereal) are not FSA eligible and should not be categorized by the tracker component 208 for a FSA category. Any changes or confirmations indicated by the user to settings/rules or categorization of items and transactions is received by the machine learning component 214 and used to learn user preferences, category rules, and/or future categorization of similar transactions. Thus, the machine learning component 214 learns patterns for, for example, specific user settings/rules, types of eligible (or not eligible) items for different tracker categories, and/or types of locations or merchants that are eligible (or not eligible) for different tracker categories.

Further still, the machine learning component 214 can learn tracker categories and can trigger the category component 206 to generate these tracker categories. For instance, assume a user, during a previous trip, established a VAT refund category but forgets to establish a new VAT refund category for a current trip, the machine learning component 214 (and/or the tracker component 208) can detect the location of a new transaction is in Europe. Based on past transaction patterns, the machine learning component 214 can determine that a new VAT refund category should be established and trigger the category component 206 to set up the new VAT refund category. Once established, the tracker component 208 can then categorize the new transaction in the new VAT refund category.

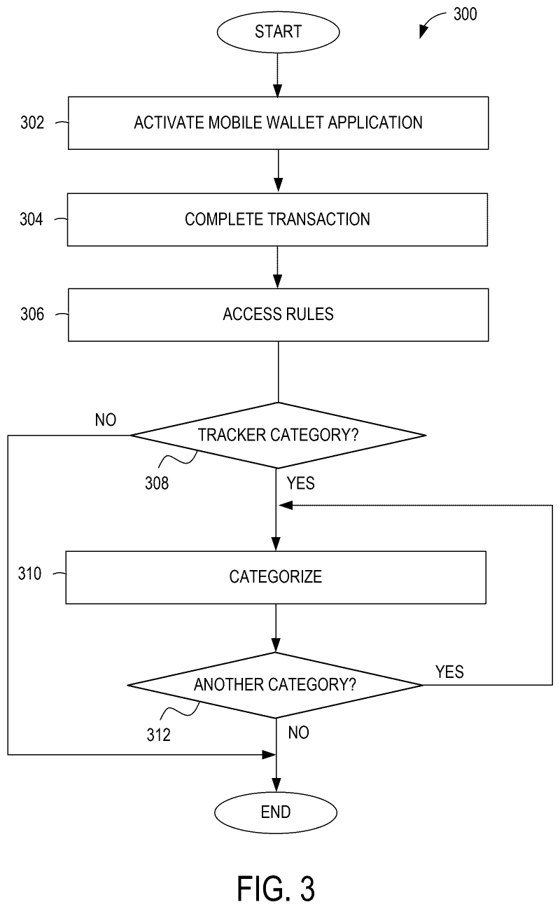

FIG. 3 is a flowchart illustrating operations of a method 300 for automatically categorizing transactions conducted using a smart wallet, according to example implementations. Operations in the method 300 can be performed by the smart wallet mobile system 108 and/or the smart wallet system 116, using components described above with respect to FIG. 2. Accordingly, the method 300 is described by way of example with reference to the smart wallet mobile system 108 and/or the smart wallet system 116. However, it shall be appreciated that at least some of the operations of the method 300 can be deployed on various other hardware configurations or be performed by similar components residing elsewhere in the network environment 100. Therefore, the method 300 is not intended to be limited to the smart wallet mobile system 108 and/or the smart wallet system 116.

In operation 302, the smart mobile wallet system 108 is activated at the mobile device 106. The smart mobile wallet system 108 can then be used to conduct a transaction. For example, the mobile device 106 can be tapped to a point-of-sale terminal, the mobile device 106 scans a QR code associated with the transaction, or the transaction information is otherwise exchanged with another device via wireless capabilities (e.g., Bluetooth, Wi-Fi, magnetic signals). In some implementations, the smart mobile wallet system 108 is transmitted (e.g., downloaded) from the smart wallet system 116.

In operation 304, the smart mobile wallet system 108 and/or the smart wallet system 116 completes the transaction. In some cases, rules are established that indicate a particular financial instrument to be used to complete the transaction. During the transaction, the rules component 204 can read a merchant category code (MCC) or detect stock keeping unit numbers (SKUs) of one or more items in the transaction. The rules component 204 then accesses the rules/settings for the user and determines which financial instrument to use. The appropriate financial instrument can be automatically used or presented on the mobile device 106 for confirmation from the user.

In some cases, a mobile identifier (e.g., mobile driver license or passport) is associated with the transaction by the smart wallet mobile system 108 and transmitted as part of the transaction details. The mobile identifier provides additional verification that it was the user that completed the transaction, even when the transaction was completed using financial instruments (e.g., cash, gift cards) that are not inherently traceable. Further still, the mobile identifier can be linked to the transaction if it is user-specific, such as for the purchase of an assigned ticket.

As the transaction is completed (e.g., at a point-of-sale terminal), the transaction details are transmitted to the smart wallet system 116. Receipt of the transaction details by the smart wallet system 116 triggers the tracker component 208 to attempt to categorize the transaction in substantially real-time as the transaction is completed. The transaction details can include date, transaction amount, merchant identifier, MCC, or a SKU associated with each item/service of the transaction.

In operation 306, the tracker component 208 access tracker category rules and corresponding rules associated with the user. The tracker categories and rules can be stored to a user profile of the user at the network system 102.

In operation 308, a determination is made whether an item in the transaction satisfies category rule(s) for a tracker category established for the user. If the item in the transaction satisfies the category rule(s), then in operation 310, the transaction is automatically categorized within the corresponding tracker category. In cases where the transaction includes more than one item and not all items are eligible, then only the items that are eligible for the tracker category are categorized.

In some cases, a transaction can involve more than one tracker category. For example, a user can be traveling for work and needs to purchase both over-the-counter medication and snacks. The over-the-counter medication would be categorized in an FSA category, while the snacks can be categorized in a business trip category. In other cases, a same item can be categorized into more than one tracker category. For example, a transaction involving a prescription can be categorized into both an FSA category and an insurance deductible category. As such, in operation 312, the tracker component 208 determines whether the transaction (or an item of the transaction) satisfies category rule(s) for a second tracker category. If the transaction satisfies the category rule(s), then the method 300 returns to operation 310 in which the tracker component 208 automatically categorizes the transaction into the second tracker category.

While the method 300 has been described above as automatically categorizing the item or transaction in the tracker category, an alternative implementation can request that the user confirm the categorization. In this implementation, a user interface is presented on the mobile device 106 indicating the transaction and a suggested tracker category for the transaction to be categorized within. The user of the mobile device 106 can confirm that the tracker category is correct, change the tracker category, or indicate that the item/transaction is not eligible for any tracker category. The user interface can be presented immediately after the completion of the transaction.

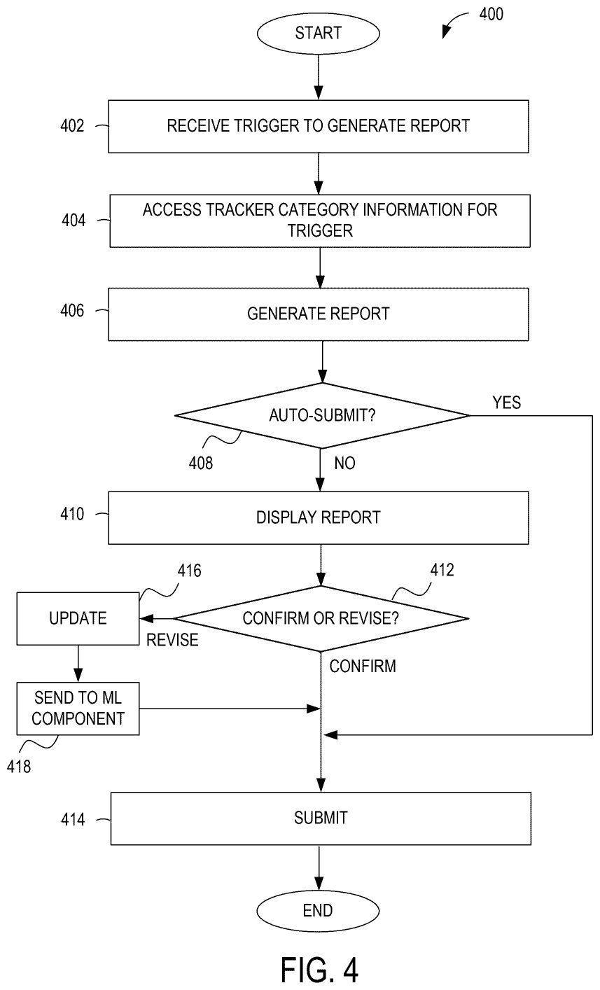

FIG. 4 is a flowchart illustrating operations of a method 400 for generating and submitting a transaction record, according to example implementations. Operations in the method 400 can be performed by the smart wallet system 116, using components described above with respect to FIG. 2. Accordingly, the method 400 is described by way of example with reference to the smart wallet system 116. However, it shall be appreciated that at least some of the operations of the method 400 can be deployed on various other hardware configurations or be performed by similar components residing elsewhere in the network environment 100. Therefore, the method 400 is not intended to be limited to the smart wallet system 116.

In operation 402, the record component 210 receives a trigger to generate a transaction record. The trigger can be based on different events and can be determined by one or more user settings established by the rules component 204. In one implementation, the trigger can be the categorization of a transaction. Thus, the transaction record is generated (and can be submitted) as soon as the transaction is categorized (e.g., in substantially real-time with completion of the transaction). In an alternative implementation, the user can explicitly trigger a request for the transaction record (e.g., via an option presented on the mobile device 106 by the smart wallet mobile system 108). In other implementations, the record component 210 is triggered to automatically provide the transaction record at particular time (e.g., monthly, beginning of tax season, on a specific date, as soon as the transaction is categorized) or based on location (e.g., at the airport, at a hospital or clinic). In the case of location, a sensor in the mobile device 106 can detect the location of the mobile device 106. The location is then transmitted to the record component 210 which can review category rules associated with tracker categories to determine if a category rule indicating location is satisfied.

In operation 404, the record component 210 accesses tracker category information for a tracker category in which the transaction record trigger was received. More specifically, the record component 210 accesses the transaction(s) that have been categorized into the tracker category. In some cases, the record component 210 accesses only transactions that have not been submitted. This can occur when the record component 210 is generating a transaction record that will be submitted to the third-party system 122. In other cases, the record component 210 access transactions for a specific time period (e.g., within the last month, since the beginning of the year, within a specified date range). This can occur when the transaction record is generated for monitoring or compliance purposes.

In operation 406, the record component 210 generates the transaction record based on the accessed tracker category information. In cases where the transaction record is to be submitted to a third-party system 122, the transaction record is generated in a format that is acceptable for submission and/or processing by the third-party system 122.

In operation 408, a determination is made whether the transaction record is to be automatically submitted. If the transaction record is not to be automatically submitted, then in operation 410, the transaction record is displayed to the user for approval. The user can confirm the transaction(s)/items(s) in the transaction record or revise the transaction record (e.g., remove an item, change an item to a different tracker category). If the user confirms, in operation 412, that everything in the transaction record is correct, the confirmation triggers the submission component 212 to submit the transaction record in operation 414.

If the user revises an element of the transaction record in operation 412, then the transaction record is updated in operation 416. Thus, the user makes a change to the transaction record and the record component 210 updates the transaction record accordingly. Additionally, the revision is provided to the machine learning component 214 in operation 418. The generation of the revised transaction record triggers the submission component 212 to submit the transaction record in operation 414.

Returning to operation 408, if the transaction record is to be automatically submitted without user confirmation or review, then the generation of the transaction record triggers the submission component 212 to automatically submit the transaction record in operation 414.

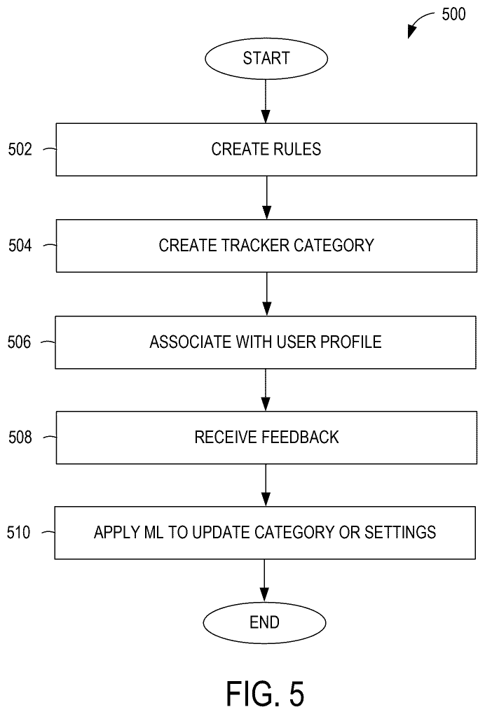

FIG. 5 is a flowchart illustrating operations of a method 500 for managing rules including machine learning updates to the rules, according to example implementations. Operations in the method 500 can be performed by the smart wallet system 116, using components described above with respect to FIG. 2. Accordingly, the method 500 is described by way of example with reference to the smart wallet system 116. However, it shall be appreciated that at least some of the operations of the method 500 can be deployed on various other hardware configurations or be performed by similar components residing elsewhere in the network environment 100. Therefore, the method 500 is not intended to be limited to the smart wallet system 116.

In operation 502, initial user settings/rules are created by the rules component 204. In some cases, the rules indicate which card should be used for specific types of transactions. In some implementations, the rules include default rules which the user can change via the rules component 204.

In operation 504, one or more tracker categories are created by the category component 206. In some cases, the tracker categories and category rules are established (e.g., selected from a drop-down menu or entered in a field) by a user. In other cases, a category or corresponding rules can be default or set by the smart wallet system 118 and the user can adjust the default rules or provide additional rules via the category component 206. The rules can indicate what types of items or transactions should be categorized for a tracker category. The type of items or transactions can be associated with a SKU in some cases. The rules can also indicate a location of transactions that should be categorized for a tracker category. For example, the rule can indicate that only transactions that occur at a doctor's office should be categorized in a HSA category. The location can be associated with a MCC. The location can also be a geographic location such as Europe for a VAT refund category. Additionally, the rules can indicate whether or which transactions should be automatically categorized without confirmation by the user and whether or which transactions require user confirmation for categorization. Further still, the rules can indicate whether and which tracker categories can have transaction records automatically generated and/or submitted without user intervention and whether and which tracker categories require some sort of user input for transaction record generation and submission. It is noted that a new tracker category can be created at any time when the new tracker category is needed.

In operation 506, the initial rules and created tracker categories are associated with a user profile of the user. In example implementations, the initial rules and created tracker categories are stored to the data storage 120.

In operation 508, the smart wallet system 116 receives feedback from the mobile device 106. The feedback can include, for example, a confirmation or revision made to a categorization and/or a confirmation or revision made to a generated transaction record. For instance, a transaction at a pharmacy can include a candy bar. This item should not be categorized into an FSA category. As such, the user can revise the categorization and/or the transaction record to reflect this change (e.g., indicate that this item is not category eligible). This feedback is received by the smart wallet system 116 (e.g., the tracker component 208 or the record component 210) and transmitted to the machine learning component 214.

In operation 510, the machine learning component 214 uses the feedback to learn patterns that can be applicable to future transactions. Specifically, the machine learning component 214 learns patterns for specific user settings, types of eligible (or not eligible) items for different tracker categories, and/or types of locations or merchants that are eligible (or not eligible) for different tracker categories. Based on the patterns, the machine learning component 214 can trigger the rules component 210 to update rules associated with the user settings or trigger the category component 206 to update category rules for a particular tracker category.

For still, the machine learning component 214 can learn tracker categories and can trigger the category component 206 to generate these tracker categories when needed. For instance, assume a user, during a previous trip, established a VAT refund category but forgets to establish a new VAT refund category for a current trip, the machine learning component 214 (and/or the tracker component 208) can detect the location of a new transaction is in Europe. Based on past transaction patterns, the machine learning component 214 can determine that a new VAT refund category should be established and trigger the category component 206 to set up the new VAT refund category.

FIG. 6 illustrates components of a machine 600, according to some example implementations, that is able to read instructions from a machine-storage medium (e.g., a machine-storage device, a non-transitory machine-storage medium, a computer-storage medium, or any suitable combination thereof) and perform any one or more of the methodologies discussed herein. Specifically, FIG. 6 shows a diagrammatic representation of the machine 600 in the example form of a computer device (e.g., a computer) and within which instructions 624 (e.g., software, a program, an application, an applet, an app, or other executable code) for causing the machine 600 to perform any one or more of the methodologies discussed herein can be executed, in whole or in part.

For example, the instructions 624 can cause the machine 600 to execute the flow diagram of FIG. 3 through FIG. 5. In one implementation, the instructions 624 can transform the machine 600 into a particular machine (e.g., specially configured machine) programmed to carry out the described and illustrated functions in the manner described.

In alternative implementations, the machine 600 operates as a standalone device or can be connected (e.g., networked) to other machines. In a networked deployment, the machine 600 can operate in the capacity of a server machine or a client machine in a server-client network environment, or as a peer machine in a peer-to-peer (or distributed) network environment. The machine 600 can be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 624 (sequentially or otherwise) that specify actions to be taken by that machine. Further, while only a single machine is illustrated, the term “machine” shall also be taken to include a collection of machines that individually or jointly execute the instructions 624 to perform any one or more of the methodologies discussed herein.

The machine 600 includes a processor 602 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 604, and a static memory 606, which are configured to communicate with each other via a bus 608. The processor 602 can contain microcircuits that are configurable, temporarily or permanently, by some or all of the instructions 624 such that the processor 602 is configurable to perform any one or more of the methodologies described herein, in whole or in part. For example, a set of one or more microcircuits of the processor 602 can be configurable to execute one or more components described herein.

The machine 600 can further include a graphics display 610 (e.g., a plasma display panel (PDP), a light emitting diode (LED) display, a liquid crystal display (LCD), a projector, or a cathode ray tube (CRT), or any other display capable of displaying graphics or video). The machine 600 can also include an input device 612 (e.g., a keyboard), a cursor control device 614 (e.g., a mouse, a touchpad, a trackball, a joystick, a motion sensor, or other pointing instrument), a storage unit 616, a signal generation device 618 (e.g., a sound card, an amplifier, a speaker, a headphone jack, or any suitable combination thereof), and a network interface device 620.

The storage unit 616 includes a machine-storage medium 622 (e.g., a tangible machine-storage medium) on which is stored the instructions 624 (e.g., software) embodying any one or more of the methodologies or functions described herein. The instructions 624 can also reside, completely or at least partially, within the main memory 604, within the processor 602 (e.g., within the processor's cache memory), or both, before or during execution thereof by the machine 600. Accordingly, the main memory 604 and the processor 602 can be considered as machine-storage media (e.g., tangible and non-transitory machine-storage media). The instructions 624 can be transmitted or received over a network 626 via the network interface device 620.

In some example implementations, the machine 600 can be a portable computing device and have one or more additional input components (e.g., sensors or gauges). Examples of such input components include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components can be accessible and available for use by any of the components described herein.

### Executable Instructions and Machine-Storage Medium

The various memories (e.g., 604, 606, and/or memory of the processor(s) 602) and/or storage unit 616 can store one or more sets of instructions and data structures (e.g., software) 624 embodying or utilized by any one or more of the methodologies or functions described herein. These instructions, when executed by processor(s) 602 cause various operations to implement the disclosed implementations.

As used herein, the terms “machine-storage medium,” “device-storage medium,” “computer-storage medium” (referred to collectively as “machine-storage medium 622”) mean the same thing and can be used interchangeably in this disclosure. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage media, computer-storage media, and/or device-storage media 622 include non-volatile memory, including by way of example semiconductor memory devices, for example, erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage medium or media, computer-storage medium or media, and device-storage medium or media 622 specifically exclude carrier waves, modulated data signals, and other such media, at least some of which are covered under the term “signal medium” discussed below. In this context, the machine-storage medium is non-transitory.

### Signal Medium

The term “signal medium” or “transmission medium” shall be taken to include any form of modulated data signal, carrier wave, and so forth. The term “modulated data signal” means a signal that has one or more of its characteristics set or changed in such a matter as to encode information in the signal.

### Computer Readable Medium

The terms “machine-readable medium,” “computer-readable medium” and “device-readable medium” mean the same thing and can be used interchangeably in this disclosure. The terms are defined to include both machine-storage media and signal media. Thus, the terms include both storage devices/media and carrier waves/modulated data signals.

The instructions 624 can further be transmitted or received over a communications network 626 using a transmission medium via the network interface device 620 and utilizing any one of a number of well-known transfer protocols (e.g., HTTP). Examples of communication networks 626 include a local area network (LAN), a wide area network (WAN), the Internet, mobile telephone networks, plain old telephone service (POTS) networks, and wireless data networks (e.g., Wi-Fi, LTE, and WiMAX networks). The term “transmission medium” shall be taken to include any intangible medium that is capable of storing, encoding, or carrying instructions 624 for execution by the machine 600, and includes digital or analog communications signals or other intangible medium to facilitate communication of such software.

Throughout this specification, plural instances can implement components, operations, or structures described as a single instance. Although individual operations of one or more methods are illustrated and described as separate operations, one or more of the individual operations can be performed concurrently, and nothing requires that the operations be performed in the order illustrated. Structures and functionality presented as separate components in example configurations can be implemented as a combined structure or component. Similarly, structures and functionality presented as a single component can be implemented as separate components. These and other variations, modifications, additions, and improvements fall within the scope of the subject matter herein.

“Component” refers, for example, to a device, physical entity, or logic having boundaries defined by function or subroutine calls, branch points, APIs, or other technologies that provide for the partitioning or modularization of particular processing or control functions. Components can be combined via their interfaces with other components to carry out a machine process. A component can be a packaged functional hardware unit designed for use with other components and a part of a program that usually performs a particular function of related functions. Components can constitute either software components (e.g., code embodied on a machine-readable medium) or hardware components.

A “hardware component” is a tangible unit capable of performing certain operations and can be configured or arranged in a certain physical manner. In various example implementations, one or more computer systems (e.g., a standalone computer system, a client computer system, or a server computer system) or one or more hardware components of a computer system (e.g., a processor or a group of processors) can be configured by software (e.g., an application or application portion) as a hardware component that operates to perform certain operations as described herein.

In some implementations, a hardware component can be implemented mechanically, electronically, or any suitable combination thereof. For example, a hardware component can include dedicated circuitry or logic that is permanently configured to perform certain operations. For example, a hardware component can be a special-purpose processor, such as a field programmable gate array (FPGA) or an ASIC. A hardware component can also include programmable logic or circuitry that is temporarily configured by software to perform certain operations. For example, a hardware component can include software encompassed within a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), can be driven by cost and time considerations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where the hardware component comprises a general-purpose processor configured by software to become a special-purpose processor, the general-purpose processor can be configured as respectively different special-purpose processors (e.g., comprising different hardware components) at different times. Software can accordingly configure a processor, for example, to constitute a particular hardware component at one instance of time and to constitute a different hardware component at a different instance of time.

Hardware components can provide information to, and receive information from, other hardware components. Accordingly, the described hardware components can be regarded as being communicatively coupled. Where multiple hardware components exist contemporaneously, communications can be achieved through signal transmission (e.g., over appropriate circuits and buses) between or among two or more of the hardware components. In examples in which multiple hardware components are configured or instantiated at different times, communications between such hardware components can be achieved, for example, through the storage and retrieval of information in memory structures to which the multiple hardware components have access. For example, one hardware component can perform an operation and store the output of that operation in a memory device to which it is communicatively coupled. A further hardware component can then, at a later time, access the memory device to retrieve and process the stored output. Hardware components can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors can constitute processor-implemented components that operate to perform one or more operations or functions described herein. As used herein, “processor-implemented component” refers to a hardware component implemented using one or more processors.

Similarly, the methods described herein can be at least partially processor-implemented, a processor being an example of hardware. For example, at least some of the operations of a method can be performed by one or more processors or processor-implemented components. Moreover, the one or more processors can also operate to support performance of the relevant operations in a “cloud computing” environment or as a “software as a service” (SaaS). For example, at least some of the operations can be performed by a group of computers (as examples of machines including processors), with these operations being accessible via a network (e.g., the Internet) and via one or more appropriate interfaces (e.g., an application program interface (API)).

The performance of certain of the operations can be distributed among the one or more processors, not only residing within a single machine, but deployed across a number of machines. In some example implementations, the one or more processors or processor-implemented components can be located in a single geographic location (e.g., within a home environment, an office environment, or a server farm). In other example implementations, the one or more processors or processor-implemented components can be distributed across a number of geographic locations.

### Examples

Example 1 is a method for automatic tracking and categorization of transactions in real-time for transaction record regeneration. The method comprises receiving, by a smart wallet system, transaction data for a transaction completed by a mobile device of a user; responsive to receiving the transaction data, triggering a tracker component of the smart wallet system to perform, in real-time as the transaction is completed, operations comprising determining whether an item of the transaction is to be categorized into a tracker category, and categorizing the item of the transaction into the tracker category in response to determining that the item of the transaction is to be categorized into the tracker category; and responsive to a record trigger event, triggering a record component of the smart wallet system to generate or update a transaction record for the tracker category. In example 2, the subject matter of example 1 can optionally include, in response to a submission trigger event, triggering a submission component of the smart wallet system to submit the transaction record to a third-party system, submission of the transaction record triggering the third-party system to process the transaction record.

In example 3, the subject matter of any of examples 1-2 can optionally include wherein the submission trigger event comprises generation of the transaction record.

In example 4, the subject matter of any of examples 1-3 can optionally include wherein the record trigger event comprises a location detected via a sensor of the mobile device.

In example 5, the subject matter of any of examples 1˜4 can optionally include wherein the smart wallet system is a smart wallet mobile system operating on the mobile device.

In example 6, the subject matter of any of examples 1-5 can optionally include determining that the item of the transaction should be categorized in a second tracker category; and in response to determining that the item should be categorized in the second tracker category, categorizing the item in the second tracker category.

In example 7, the subject matter of any of examples 1-6 can optionally include determining that a second item of the transaction should be categorized; and in response to determining that the second item of the transaction should be categorized, categorizing the second item into one of the tracker category or a second tracker category.

In example 8, the subject matter of any of examples 1-7 can optionally include receiving feedback from the mobile device, the feedback indicating a revision to a categorization; and identifying, by a machine learning component of the smart wallet system, a new or revised rule for a user setting or the tracker category.

In example 9, the subject matter of any of examples 1-8 can optionally include wherein the receiving the transaction data includes receiving the transaction data via wireless communication between the mobile device and a point-of-sale terminal.

In example 10, the subject matter of any of examples 1-9 can optionally include causing display of the transaction record on the mobile device; and receiving either a confirmation of or a revision to the transaction record.

In example 11, the subject matter of any of examples 1-10 can optionally include wherein the smart wallet system is configured to track and categorize transactions performed using a plurality of different payment instruments.

In example 12, the subject matter of any of examples 1-11 can optionally include wherein the record trigger event comprises the categorizing of the item into the tracker category.

In example 13, the subject matter of any of examples 1-12 can optionally include generating the tracker category via a user interface presented on the mobile device, the generating including receiving one or more inputs via one or more drop-down menus or fields presented on the user interface that indicate the tracker category and associated rules for categorization.

In example 14, the subject matter of any of examples 1-13 can optionally include automatically generating, by the smart wallet system, the tracker category in response to the receiving of the transaction data, the automatically generating being based on machine-learning based on at least past transaction data and a past tracker category.

In example 15, the subject matter of any of examples 1-14 can optionally include wherein the transactions data includes a linked mobile identifier, the linked mobile identifier providing verification that the user completed the transaction; and the transaction record indicates that the transaction was verified using the linked mobile identifier.

In example 16, the subject matter of any of examples 1-15 can optionally include providing a smart wallet mobile system to the mobile device, the smart wallet mobile system configuring the mobile device to present and append a mobile identifier to the transaction data at a point-of-sale terminal.

Example 17 is a system for automatic tracking and categorization of transactions in real-time for transaction record regeneration. The system comprises one or more processors and a memory storing instructions that, when executed by the one or more processors, cause the one or more processors to perform operations comprising receiving, by a smart wallet system, transaction data for a transaction completed by a mobile device of a user; responsive to receiving the transaction data, triggering a tracker component of the smart wallet system to perform, in real-time as the transaction is completed, operations comprising determining whether an item of the transaction is to be categorized into a tracker category, and categorizing the item of the transaction into the tracker category in response to determining that the item of the transaction is to be categorized into the tracker category; and responsive to a record trigger event, triggering a record component of the smart wallet system to generate or update a transaction record for the tracker category.

In example 18, the subject matter example 17 can optionally include wherein the operations further comprise, in response to a submission trigger event, triggering a submission component of the smart wallet system to submit the transaction record to a third-party system, submission of the transaction record triggering the third-party system to process the transaction record.

In example 19, the subject matter of any of examples 17-18 can optionally include wherein the operations further comprise receiving feedback from the mobile device, the feedback indicating a revision to a categorization; and identifying, by a machine learning component of the smart wallet system, a new or revised rule for a user setting or the tracker category.

Example 20 is a computer-storage medium comprising instructions which, when executed by one or more processors of a machine, cause the machine to perform operations for automatic tracking and categorization of transactions in real-time for transaction record regeneration. The operations receiving, by a smart wallet system, transaction data for a transaction completed by a mobile device of a user; responsive to receiving the transaction data, triggering a tracker component of the smart wallet system to perform, in real-time as the transaction is completed, operations comprising determining whether an item of the transaction is to be categorized into a tracker category, and categorizing the item of the transaction into the tracker category in response to determining that the item of the transaction is to be categorized into the tracker category; and responsive to a record trigger event, triggering a record component of the smart wallet system to generate or update a transaction record for the tracker category.

Some portions of this specification can be presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities can take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like can refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

Although an overview of the present subject matter has been described with reference to specific examples, various modifications and changes can be made to these examples without departing from the broader scope of examples of the present invention. For instance, various examples or features thereof can be mixed and matched or made optional by a person of ordinary skill in the art. Such examples of the present subject matter can be referred to herein, individually or collectively, by the term “invention” merely for convenience and without intending to voluntarily limit the scope of this application to any single invention or present concept if more than one is, in fact, disclosed.

The examples illustrated herein are believed to be described in sufficient detail to enable those skilled in the art to practice the teachings disclosed. Other examples can be used and derived therefrom, such that structural and logical substitutions and changes can be made without departing from the scope of this disclosure. The Detailed Description, therefore, is not to be taken in a limiting sense, and the scope of various examples is defined only by the appended claims, along with the full range of equivalents to which such claims are entitled.

Moreover, plural instances can be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and can fall within a scope of various examples of the present invention. In general, structures and functionality presented as separate resources in the example configurations can be implemented as a combined structure or resource. Similarly, structures and functionality presented as a single resource can be implemented as separate resources. These and other variations, modifications, additions, and improvements fall within a scope of examples of the present invention as represented by the appended claims. The specification and drawings are, accordingly, to be regarded in an illustrative rather than a restrictive sense.

What is claimed is:

1. A computer-implemented method for real-time tracking and categorization of transactions, the method comprising:
receiving, by a smart wallet system, transaction data for a transaction completed by a mobile device of a user;
responsive to receiving the transaction data, triggering a tracker component of the smart wallet system to perform, in real-time as the transaction is completed, operations comprising:
determining whether an item of the transaction is to be categorized into a tracker category; and
categorizing the item of the transaction into the tracker category in response to determining that the item of the transaction is to be categorized into the tracker category; and
responsive to a record trigger event, triggering a record component of the smart wallet system to generate or update a transaction record for the tracker category.

2. The method of claim 1, further comprising:
in response to a submission trigger event, triggering a submission component of the smart wallet system to submit the transaction record to a third-party system, submission of the transaction record triggering the third-party system to process the transaction record.

3. The method of claim 2, wherein the submission trigger event comprises generation of the transaction record.

4. The method of claim 1, wherein the record trigger event comprises a location detected via a sensor of the mobile device.

5. The method of claim 1, wherein the smart wallet system is a smart wallet mobile system operating on the mobile device.

6. The method of claim 1, further comprising:
determining that the item of the transaction should be categorized in a second tracker category; and
in response to determining that the item should be categorized in the second tracker category, categorizing the item in the second tracker category.

7. The method of claim 1, further comprising:
determining that a second item of the transaction should be categorized; and
in response to determining that the second item of the transaction should be categorized, categorizing the second item into one of the tracker category or a second tracker category.

8. The method of claim 1, further comprising:
receiving feedback from the mobile device, the feedback indicating a revision to a categorization; and
identifying, by a machine learning component of the smart wallet system, a new or revised rule for a user setting or the tracker category.

9. The method of claim 1, wherein the receiving the transaction data includes receiving the transaction data via wireless communication between the mobile device and a point-of-sale terminal.

10. The method of claim 1, further comprising:
causing display of the transaction record on the mobile device; and
receiving either a confirmation of or a revision to the transaction record.

11. The method of claim 1, wherein the smart wallet system is configured to track and categorize transactions performed using a plurality of different payment instruments.

12. The method of claim 1, wherein the record trigger event comprises the categorizing of the item into the tracker category.

13. The method of claim 1, further comprising generating the tracker category via a user interface presented on the mobile device, the generating including receiving one or more inputs via one or more drop-down menus or fields presented on the user interface that indicate the tracker category and associated rules for categorization.

14. The method of claim 1, further comprising automatically generating, by the smart wallet system, the tracker category in response to the receiving of the transaction data, the automatically generating being based on machine-learning based on at least past transaction data and a past tracker category.

15. The method of claim 1, wherein:
the transactions data includes a linked mobile identifier, the linked mobile identifier providing verification that the user completed the transaction; and
the transaction record indicates that the transaction was verified using the linked mobile identifier.

16. The method of claim 1, further comprising providing a smart wallet mobile system to the mobile device, the smart wallet mobile system configuring the mobile device to present and append a mobile identifier to the transaction data at a point-of-sale terminal.

17. A system comprising:
one or more processors; and
a memory storing instructions that, when executed by the one or more processors, cause the one or more processors to perform operations comprising:
receiving, by a smart wallet system, transaction data for a transaction completed by a mobile device of a user;
responsive to receiving the transaction data, triggering a tracker component of the smart wallet system to perform, in real-time as the transaction is completed, operations comprising:
determining whether an item of the transaction is to be categorized into a tracker category; and
categorizing the item of the transaction into the tracker category in response to determining that the item of the transaction is to be categorized into the tracker category; and
responsive to a record trigger event, triggering a record component of the smart wallet system to generate or update a transaction record for the tracker category.

18. The system of claim 17, wherein the operations further comprise:
in response to a submission trigger event, triggering a submission component of the smart wallet system to submit the transaction record to a third-party system, submission of the transaction record triggering the third-party system to process the transaction record.

19. The system of claim 17, wherein the operations further comprise:
receiving feedback from the mobile device, the feedback indicating a revision to a categorization; and
identifying, by a machine learning component of the smart wallet system, a new or revised rule for a user setting or the tracker category.

20. A machine-storage medium comprising instructions which, when executed by one or more processors of a machine, cause the machine to perform operations comprising:
receiving, by a smart wallet system, transaction data for a transaction completed by a mobile device of a user;
responsive to receiving the transaction data, triggering a tracker component of the smart wallet system to perform, in real-time as the transaction is completed, operations comprising:
determining whether an item of the transaction is to be categorized into a tracker category; and
categorizing the item of the transaction into the tracker category in response to determining that the item of the transaction is to be categorized into the tracker category; and
responsive to a record trigger event, triggering a record component of the smart wallet system to generate or update a transaction record for the tracker category.
